(19) United States
(12) Patent Application Publication
(10) Pub. No.: US 2023/0024582 A1
(43) Pub. Date: Jan. 26, 2023

(54) LOW POLYMER CONTENT PROPYLENE POLYMER-BASED HOT MELT ADHESIVE COMPOSITION

(71) Applicant: H.B. Fuller Company, St. Paul, MN (US)

(72) Inventor: Thomas F. Kauffman, Woodbury, MN (US)

(21) Appl. No.: 17/810,986

(22) Filed: Jul. 6, 2022

Related U.S. Application Data
(60) Provisional application No. 63/203,040, filed on Jul. 6, 2021.

(51) Int. Cl. C09J 123/12; C09J 123/14; C09J 7/35; C09J 7/10

(52) U.S. Cl. CPC C09J 123/12; C09J 123/142; C09J 7/35; C09J 7/10; C09J 2301/304; C09J 2301/414

(57) ABSTRACT

The hot melt adhesive composition includes from 1% by weight to less than 10% by weight total polymer content, of which less than 10% by weight, based on the hot melt adhesive composition, is a single site-catalyzed propylene polymer selected from the group consisting of a single site-catalyzed propylene homopolymer, a single site-catalyzed propylene/alpha-olefin copolymer, and combinations thereof, liquid plasticizer, and at least 45% by weight of a hydrocarbon tackifying agent having a softening point greater than 90° C.

### CROSS REFERENCE TO RELATED APPLICATIONS

This application claims the benefit of U.S. Provisional Application No. 63/203,040, filed Jul. 6, 2021, which is incorporated herein.

### BACKGROUND

The invention is directed to formulating propylene polymer-based hot melt adhesive compositions that have low polymer content and to formulating propylene polymer-based hot melt adhesive compositions that have low polymer content, high plasticizer content, and can be applied at low temperatures.

A variety of classes of hot melt adhesive compositions are used in the manufacture of disposable articles such as diapers and feminine care products including construction adhesives, elastic attachment adhesives, and positioning adhesives. Construction adhesives are often used to bond a back sheet to a nonwoven web. Elastic attachment adhesives are often used to bond elastic material to a back sheet (e.g., in the area of the leg or waist band portion of the article). Positioning adhesives are used to bond a feminine care product to clothing.

The properties required for a commercially useful adhesive composition that is suitable for use in one application often differ from the properties required for a commercially useful adhesive composition that is suitable for use in another application. Construction adhesives, for example, must exhibit good bond strength to polyethylene films and nonwoven webs so as to maintain such substrates adhered to one another during use of the article. Construction adhesives also must be capable of being applied to a heat sensitive substrate such as a nonwoven web or a polyethylene film at a temperature (which is often referred to as the application temperature) that is sufficiently low such that the adhesive will not damage the heat sensitive substrate.

A variety of base polymers have been used in the formulation of hot melt adhesive compositions. Although high molecular weight propylene polymers have been added in minor amounts to hot melt adhesive compositions, high molecular weight propylene polymers typically have not been used as the base polymer in such compositions due to their perceived poor machining, as demonstrated by poor flow and poor cutoff. High molecular weight propylene polymers also can be difficult to formulate into commercially viable hot melt adhesive compositions because they tend to increase the viscosity of the resulting composition.

High viscosity hot melt adhesive compositions must be heated to a relatively high temperature before being applied to a substrate using existing applicators. In disposable diaper manufacturing, for example, if the required application temperature is too high, the heat sensitive substrates used in the construction of the diaper will be damaged during the coating operation. Hot melt adhesive compositions that can be applied at relatively lower temperatures can improve the safety associated with using the composition and decrease the odor generated by the composition in the manufacturing environment.

Plasticizers, such as oils, are often used to decrease the viscosity of an adhesive composition and to soften an adhesive composition. However, increasing the plasticizer content in a composition can decrease the cohesive strength of the adhesive composition and deteriorate its adhesive bond performance.

There is a need for an alternative hot melt adhesive composition that includes low polymer content, high plasticizer content, and can be applied at relatively low application temperatures and exhibit good peel adhesion to substrates used in the construction of disposable hygiene products such as the polyethylene films and nonwoven webs used in disposable diapers.

### SUMMARY

In one aspect, the invention features a hot melt adhesive composition that includes from 1% by weight to less than 10% by weight total polymer content, of which from 1% by weight to less than 10% by weight, based on the weight of the hot melt adhesive composition, includes a single-site catalyzed propylene polymer selected from the group consisting of single-site catalyzed propylene homopolymer, single-site catalyzed propylene/alpha-olefin copolymer, and combinations thereof, liquid plasticizer, and from 45% by weight to 60% by weight hydrocarbon tackifying agent having a softening point greater than 90° C., the composition exhibiting a viscosity of no greater than 5000 centipoise (cP) at 149° C. In one embodiment, the hot melt adhesive composition includes from greater than 25% by weight to 45% by weight of the liquid plasticizer. In another embodiment, the hot melt adhesive composition includes from 30% by weight to 45% by weight of the liquid plasticizer. In other embodiments, the hot melt adhesive composition includes from 35% by weight to 45% by weight of the liquid plasticizer.

In one embodiment, the hydrocarbon tackifying agent includes a tackifying agent having a softening point of at least 110° C. In another embodiment, the single-site catalyzed propylene polymer is selected from the group consisting of a single-site catalyzed propylene homopolymer having a melt flow rate of less than 100 g/10 min at 230° C. using a 2.16 kg load and a Tg greater than −20° C., a single-site catalyzed propylene/alpha-olefin copolymer having a melt flow rate less than 50 g/10 min at 230° C. using a 2.16 kg load and a Tg greater than −40° C., and combinations thereof.

In some embodiments, the composition includes from 1% by weight to 5% by weight of a single-site catalyzed propylene homopolymer. In one embodiment, the composition includes the single-site catalyzed propylene homopolymer and the single-site catalyzed propylene/alpha-olefin copolymer. In other embodiments, the composition includes from 1% by weight to 5% by weight of the single-site catalyzed propylene homopolymer and from 3% by weight to 7% by weight of the single-site catalyzed propylene/alpha-olefin copolymer.

In some embodiments, the single-site catalyzed propylene/alpha-olefin copolymer has an alpha-olefin comonomer content of no greater than 18% by weight.

In some embodiments, the composition includes the single-site catalyzed propylene/alpha-olefin copolymer, and the single-site catalyzed propylene/alpha-olefin copolymer has a melt flow rate no greater than 25 g/10 min at 230° C. using a 2.16 kg load.

In other embodiments, the single-site catalyzed propylene polymer is selected from the group consisting of the single-site catalyzed propylene homopolymer having a melt flow rate of less than 100 g/10 min at 230° C. using a 2.16 kg load and a Tg greater than −20° C., the single-site catalyzed propylene/alpha-olefin copolymer having a melt flow rate less than 50 g/10 min at 230° C. using a 2.16 kg load and a Tg greater than −40° C. and an alpha-olefin comonomer content of no greater than 18% by weight, and combinations thereof.

In another embodiment, the composition exhibits a Tg of from 0° C. to 30° C.

In some embodiments, the composition exhibits a crossover temperature of at least 80° C.

In one embodiment, the single-site catalyzed propylene polymer has a melt flow rate of no greater than 30 g/10 min at 230° C. using a 2.16 kg load.

In another embodiment, the composition exhibits a viscosity of no greater than 5000 cP at 135° C. In other embodiments, the composition exhibits a viscosity of no greater than 5000 cP at 121° C. In another embodiment, the composition exhibits a viscosity of no greater than 5000 cP at 107° C.

In some embodiments, the polymer content further includes from 1% by weight to 5% by weight styrene block copolymer based on the weight of the hot melt adhesive composition.

In one embodiment, the composition further includes wax. In some embodiments, the composition further includes from 1% by weight to 3% by weight wax.

In other embodiments, the liquid plasticizer includes naphthenic oil, paraffinic oil, mineral oil, natural gas to liquid oil, or a combination thereof.

In one embodiment, the composition exhibits a peel adhesion of at least 300 grams of force per 3 inch when tested according to the Peel Adhesion test method.

In other embodiments, the single-site catalyzed propylene polymer is selected from the group consisting of a single-site catalyzed propylene homopolymer having a melt flow rate of less than 100 g/10 min at 230° C. using a 2.16 kg load, a propylene/alpha-olefin copolymer having a melt flow rate of less than 50 g/10 min at 230° C. using a 2.16 kg load, and combinations thereof.

In another embodiment, the single-site catalyzed propylene polymer includes a single-site catalyzed propylene homopolymer having a melt flow rate of less than 100 g/10 min at 230° C. using a 2.16 kg load and a single-site catalyzed propylene/alpha-olefin copolymer having a melt flow rate of less than 50 g/10 min at 230° C. using a 2.16 kg load.

In some embodiments, the composition includes from 1% by weight to 5% by weight of the single-site catalyzed propylene homopolymer.

In other embodiments, the hydrocarbon tackifying agent includes a tackifying agent having a softening point of at least 100° C.

In other embodiments, the hot melt adhesive composition includes from 1% by weight to less than 10% by weight total polymer content of which from 1% by weight to less than 10% by weight, based on the weight of the hot melt adhesive composition, includes a single-site catalyzed propylene polymer selected from the group consisting of a single-site catalyzed propylene homopolymer having a melt flow rate of less than 100 g/10 min at 230° C. using a 2.16 kg load and a Tg greater than −20° C., a single-site catalyzed propylene/alpha-olefin copolymer having a melt flow rate less than 50 g/10 min at 230° C. using a 2.16 kg load and a Tg greater than −40° C., and combinations thereof, liquid plasticizer (e.g., from greater than 25% by weight to 45% by weight liquid plasticizer, from 30% by weight to 45% by weight liquid plasticizer, or even from 35% by weight to 45% by weight liquid plasticizer), and from 45% by weight to 60% by weight hydrocarbon tackifying agent having a softening point of at least 110° C., the composition exhibiting a viscosity of no greater than 5000 centipoise (cP) at 149° C. In some embodiments, the composition exhibits a viscosity of no greater than 5000 cP at 121° C., or even at 107° C. In other embodiments, the composition further includes a wax, or even from 1% by weight to 3% by weight wax.

In another aspect, the invention features an article that includes a hot melt adhesive composition disclosed herein, a first substrate, and a second substrate bonded to the first substrate through the hot melt adhesive composition.

The invention features a hot melt adhesive composition that includes a relatively low total polymer content and a relatively high amount of plasticizer, exhibits good adhesion to substrates used in the construction of disposable hygiene products such as polyethylene films and polypropylene nonwoven webs, and can be applied at relatively low application temperatures including application temperatures as low as 149° C., 135° C., or even 121° C.

The present inventor has surprisingly discovered that a useful hot melt adhesive composition can be formulated with less than 10% by weight total polymer content. It is unexpected that a hot melt adhesive composition with such a small amount of polymer could form good adhesive bonds to substrates used in disposable diaper manufacturing including such substrates as polyethylene films and nonwoven webs.

The present inventor also has surprisingly discovered that a useful hot melt adhesive composition can be formulated with less than 10% by weight total polymer content and at least 35% by weight liquid plasticizer. It is unexpected that a hot melt adhesive composition with such a large amount of plasticizer and such a small amount of polymer could form good adhesive bonds to substrates used in disposable diaper manufacturing including such substrates as polyethylene films and nonwoven webs.

Other features and advantages will be apparent from the following description of the preferred embodiments and from the claims.

### DETAILED DESCRIPTION

The hot melt adhesive composition includes a total polymer content of less than 10% by weight, a single-site catalyzed propylene polymer, plasticizer, and a hydrocarbon tackifying agent having a softening point of at least 90° C. The hot melt adhesive composition exhibits a peel adhesion of at least 300 grams of force per 3 inch (7.62 centimeters) (gf/3 inch), at least 400 gf/3 inch, or even at least 500 gf/3 inch when tested according to the Peel Adhesion test method, or at least about 0.1 Newtons per centimeter (N/cm), at least about 0.5 N/cm, or even at least about 0.6 N/cm when tested according to the Peel Adhesion test method and converted to Newtons per centimeter.

The hot melt adhesive composition exhibits a glass transition temperature (Tg) of from 0° C. to 30° C., from 5° C. to 30° C., from 10° C. to 30° C., or even from 15° C. to 30° C.

The hot melt adhesive composition exhibits a crossover temperature (Tx) of at least 75° C., at least 80° C., or even at least 85° C.

The hot melt adhesive composition also exhibits a viscosity of no greater than 5000 centipoise (cP), no greater than 4000 cP, no greater than 3000 cP, or even no greater than 2000 cP at 149° C., at 135° C., at 121° C., or even at 107° C.

The hot melt adhesive composition preferably exhibits good thermal stability such that it is free of phase separation, free of char, does not gel, and exhibits less than 50% change in viscosity after aging for 200 hours in a molten state.

### Polymer

The hot melt adhesive composition includes a total polymer content of from 1% by weight to less than 10% by weight. The polymer content of the hot melt adhesive composition includes a single-site catalyzed propylene polymer and optionally at least one additional polymer.

### Single-Site Catalyzed Propylene Polymer

A single-site catalyzed propylene polymer is a propylene polymer that includes greater than 50% by weight propylene and less than 50% alpha-olefin comonomer and is formed from a single-site catalyzed polymerization process such as a metallocene catalyzed polymerization process. Useful single-site catalyzed propylene polymers have a melt flow rate of less than 100 g/10 min at 230° C. using a 2.16 kg load when tested according to ASTM D1238A-20, a density of no greater than 0.88 g/cm³, and a polydispersity index of no greater than 4.

The single-site catalyzed propylene polymer can be a single single-site catalyzed propylene polymer or a combination of multiple different single-site catalyzed propylene polymers. Useful single-site catalyzed propylene polymers include, e.g., single-site catalyzed propylene homopolymers, single-site catalyzed propylene/alpha-olefin copolymers, and combinations thereof. Single-site catalyzed propylene homopolymers preferably have a Tg greater than −20° C. and a melt flow rate of less than 100 g/10 min, less than 80 g/10 min, less than 70 g/10 min, or even less than 60 g/10 min at 230° C. using a 2.16 kg load when tested according to ASTM D1238A-20.

Single-site catalyzed propylene/alpha-olefin copolymers preferably have a Tg greater than −40° C. and a melt flow rate less than 50 g/10 min, less than 40 g/10 min, less than 30 g/10 min, or even less than 25 g/10 min at 230° C. using a 2.16 kg load when tested according to ASTM D1238A-20. A particularly useful single-site catalyzed propylene polymer component includes both 1) a single-site catalyzed propylene homopolymer having a Tg greater than −20° C. and a melt flow rate of less than 100 g/10 min at 230° C. using a 2.16 kg load, and 2) a single-site catalyzed propylene/alpha-olefin copolymer having a Tg greater than −40° C., and a melt flow rate of less than 50 g/10 min at 230° C. using a 2.16 kg load.

Suitable single-site catalyzed propylene/alpha-olefin copolymers are derived from propylene and at least one alpha-olefin comonomer examples of which include alpha-olefin comonomers having from two to ten carbon atoms including, e.g., ethylene, butene, 1,4-methylpentene, hexene, octene, and combinations thereof. Useful single-site catalyzed propylene/alpha-olefin copolymers have a comonomer content of no greater than 18% by weight, no greater than 17% by weight, from 9% by weight to 18% by weight, or even from 9% by weight to 16% by weight.

Specific examples of useful single-site catalyzed propylene polymers include metallocene-catalyzed polypropylene, metallocene-catalyzed propylene/ethylene copolymer, metallocene-catalyzed propylene/butene, metallocene-catalyzed propylene/ethylene/butene, metallocene-catalyzed propylene/hexene, metallocene-catalyzed propylene/octene copolymers, and combinations thereof.

Useful commercially available single-site catalyzed propylene polymers are available under a variety of trade designations including, e.g., the metallocene-catalyzed polymers available under the VISTAMAXX series of trade designations from ExxonMobil Chemical Company (Houston, Tex.) including VISTAMAXX 6102 and VISTAMAXX 6202 metallocene catalyzed propylene/ethylene copolymers, the single-site catalyzed polymers available under the LMODU series of trade designations from Idemitsu Kosan Co., Ltd. (Tokyo, Japan) including LMODU 5901 metallocene catalyzed polypropylene, and the single-site catalyzed polymers available under the VERSIFY series of trade designations from The Dow Chemical Company (Midland, Mich.) including VERSIFY 3401 and VERSIFY 4301 single-site catalyzed propylene/ethylene copolymers.

The single-site catalyzed propylene polymer is present in the hot melt adhesive composition in an amount of at least 1% by weight, at least 2% by weight, at least 3% by weight, at least 5% by weight, less than 10% by weight, from 1% by weight to less than 10% by weight, from 2% by weight to 9% by weight, or even from 3% by weight to 9% by weight. Particularly useful single-site catalyzed propylene polymers include from 1% by weight to 9% by weight, 1% by weight to no greater than 5% by weight, from 1% by weight to 4% by weight, or even from 1% by weight to 3% by weight of a single-site catalyzed propylene homopolymer having a Tg greater than −20° C. and a melt flow rate of less than 100 g/10 min at 230° C. using a 2.16 kg load, from 1% by weight to 9% by weight, from 2% by weight to 8% by weight, from 2% by weight to 7% by weight, or even from 3% by weight to 6% by weight of a single-site catalyzed propylene/alpha-olefin copolymer having a Tg greater than −40° C. and a melt flow rate of less than 50 g/10 min at 230° C. using a 2.16 kg load, and combinations thereof (e.g., propylene polymer blends).

### Optional Additional Polymer

The optional additional polymers that are suitable for use in the composition and that contribute to the total polymer content of the hot melt adhesive composition include, e.g., a styrenic block copolymer, ethylene-based polymers, butene-1-based polymers, functionalized copolymers (e.g., maleic anhydride functionalized copolymers (e.g., maleic anhydride functionalized styrene block copolymers, maleic anhydride functionalized ethylene-based polymers, and maleic anhydride functionalized butene-1-based polymers)), and combinations thereof. The adhesive composition optionally includes no greater than 5% by weight, no greater than 3% by weight, from 0% by weight to 5% by weight, from 1% by weight to 5% by weight, from 1.5% by weight to 5% by weight, or even from 2% by weight to 5% by weight of additional polymer other than the polypropylene polymer.

### Styrenic Block Copolymer

The optional styrenic block copolymer can be in a variety of forms including, e.g., triblock, radial, multiblock, tapered, and combinations thereof, and preferably is a triblock copolymer. Useful styrenic block copolymers include styrene end blocks (A) and at least one midblock (B). Preferably the styrenic block copolymer includes no greater than 40% by weight styrene, no greater than 35% by weight styrene, or even no greater than 30% by weight styrene. Suitable end blocks (A) include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, and combinations thereof. Useful midblocks include, e.g., elastomeric conjugated dienes (e.g., hydrogenated and unhydrogenated conjugated dienes), sesquiterpenes (e.g., hydrogenated and nonhydrogenated sesquiterpenes), and combinations thereof. Suitable midblocks (B) include elastomeric conjugated diene blocks including, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof (e.g., ethylene/butylene and ethylene/propylene). Suitable midblock B sesquiterpenes include, e.g., beta farnesene.

Useful styrenic triblock copolymers include, e.g., styrene-butadiene-styrene, styrene-isoprene-styrene, styrene-ethylene-butylene-styrene, styrene-ethylene-propylene-styrene, styrene-ethylene-butylene-styrene-styrene, and combinations thereof, and functionalized versions thereof. Particularly useful examples of styrenic triblock copolymers include hydrogenated styrenic block copolymers including styrene-ethylene-butylene-styrene, styrene-ethylene-propylene-styrene, and combinations thereof. The hot melt adhesive composition formulated with a hydrogenated styrenic block copolymer exhibits improved thermal stability relative to the hot melt adhesive composition formulated with a non-hydrogenated styrenic block copolymer.

Useful styrenic triblock copolymers are commercially available under a variety of trade designations including, e.g., the KRATON series of trade designations from Kraton Corporation (Houston, Tex.) including, e.g., KRATON G1650 styrene-ethylene-butylene-styrene, the VECTOR series of trade designations from Taiwan Synthetic Rubber Corporation (TSRC) (Taipei City, Taiwan) including, e.g., VECTOR 4211 styrene-isoprene-styrene having a styrene content of 30% by weight as reported by the manufacturer, TAIPOL 6150 M styrene-ethylene-butylene-styrene having a styrene content of from 27.5% by weight to 30.5% by weight as reported by the manufacturer TSRC, and GLOBALPRENE 9550 styrene-ethylene-butylene-styrene having a styrene content of 30% by weight as reported by the manufacturer LCY Group (Lee Chang Yung Chemical Industry Corp., Guangdong, China).

The adhesive composition optionally includes no greater than 5% by weight, no greater than 3% by weight, from 0% by weight to 5% by weight, from 1% by weight to 5% by weight, from 1.5% by weight to 5% by weight, or even from 2% by weight to 5% by weight styrenic block copolymer.

### Ethylene Polymer

Useful optional ethylene polymers include, e.g., polyethylene homopolymer, polyethylene/alpha-olefin copolymer, and combinations thereof. The term “ethylene polymer” means polymer derived from greater than 50% by weight ethylene and less than 50% by weight alpha-olefin comonomer. Useful alpha-olefin comonomers from which an ethylene/alpha-olefin copolymer can be derived include, e.g., alpha-olefin monomers having at least three carbon atoms, at least four carbon atoms, from three carbon atoms to eight carbon atoms, and combinations thereof. Suitable examples of alpha-olefin co-monomers include propylene, butene, pentene, hexene, heptene, octene, nonene, decene, dodecene, 4-methyl-pentene-1,3-methyl pentene-1,3,5,5-trimethyl-hexene-1,5-ethyl-1-nonene, 1,9-decadiene, and combinations thereof. Specific examples of suitable ethylene-alpha-olefin copolymers include ethylene-propylene, ethylene-butene, ethylene-hexene, ethylene-octene, and combinations thereof, and functionalized versions thereof.

The ethylene polymer can be prepared using a variety of catalysts including, e.g., a single site catalyst (e.g., metallocene catalysts (e.g., metallocene-catalyzed propylene polymers)), multiple single site catalysts, non-metallocene heteroaryl catalysts, Ziegler-Natta catalysts, and combinations thereof.

Useful ethylene polymers are available under a variety of trade designations including, e.g., EPOLENE C-13 polyethylene and EPOLENE C-17 polyethylene from Westlake Chemical Corporation (Houston, Tex.).

The adhesive composition optionally includes no greater than 5% by weight, no greater than 3% by weight, from 0% by weight to 5% by weight, from 1% by weight to 5% by weight, from 1.5% by weight to 5% by weight, or even from 2% by weight to 5% by weight ethylene polymer.

### Polybutene-1 Polymer

Useful optional polybutene-1 polymers include polybutene-1 homopolymers and polybutene-1 copolymers including, e.g., metallocene-catalyzed polybutene-1 homopolymers, metallocene-catalyzed polybutene-1 copolymers, and combinations thereof, and functionalized versions thereof. The term “polybutene-1 polymer” means a polymer derived from greater than 50% by weight butene and less than 50% by weight alpha-olefin comonomer. Useful alpha-olefin comonomers include, e.g., ethylene, propylene, hexene, octene, and combinations thereof. One example of a useful commercially available metallocene-catalyzed polybutene-1 polymer is KOATTRO PB M 600M random polybutene-1/ethylene copolymer from LyondellBasell Industries NV (Rotterdam, Netherlands).

The adhesive composition optionally includes no greater than 5% by weight, no greater than 3% by weight, from 0% by weight to 5% by weight, from 1% by weight to 5% by weight, from 1.5% by weight to 5% by weight, or even from 2% by weight to 5% by weight polybutene-1polymer.

### Plasticizer

The hot melt adhesive composition includes a plasticizer that is liquid at room temperature. The term “liquid,” as used in reference to the plasticizer, means that the plasticizer exhibits a kinematic viscosity of no greater than 5000 centistokes (cS) at 25° C. as determined according to ASTM D445 and a pour point of no greater than 30° C. as determined according to ASTM D97. Useful classes of plasticizers include, e.g., oils, and oligomeric and low molecular weight polymeric plasticizers that are liquid at room temperature. Particularly useful plasticizers include naphthenic oil, paraffinic oil (e.g., cycloparaffin oils), mineral oil, gas to liquid oils, and combinations thereof.

Useful plasticizers are commercially available under a variety of trade designations including, e.g., CALSOL 5550 naphthenic oil and DRAKEOL 35 paraffinic oil from Calumet Specialty Products Partners, LP (Indianapolis, Ind.), PURETOL 35 paraffinic oil from Petro-Canada Lubricants Inc. (Ontario, Canada), CATENEX T145 paraffinic oil from Shell Oil Products US (Houston, Tex.), NYFLEX 223 naphthenic oil from Nynas AB (Stockholm, Sweden), KAYDOL mineral oil from Sonneborn (Tarrytown N.Y.), KRYSTOL 550 mineral oil from Petrochem Carless Limited (Surrey, England), and RISELLA X430 natural gas to liquid oil from Shell Oil Products US (Houston, Tex.).

The hot melt adhesive composition preferably includes greater than 25% by weight, at least 30% by weight, at least 35% by weight, at least 40% by weight, from 35% by weight to 45% by weight, from 37% by weight to 45% by weight, or even from 38% by weight to 43% by weight plasticizer.

### Tackifying Agent

The hot melt adhesive composition includes at least one hydrocarbon tackifying agent. The hydrocarbon tackifying agent has a softening point greater than 90° C., of at least 100° C., at least 110° C., at least 115° C., or even of at least 120° C. as determined by ASTM E28-58T. Useful tackifying agents include, e.g., aliphatic and cycloaliphatic petroleum hydrocarbon tackifying agents, mixed aromatic and aliphatic modified hydrocarbon tackifying agents, aromatic modified aliphatic hydrocarbon tackifying agents, hydrogenated derivatives thereof, polyterpenes, and combinations thereof, including, e.g., branched, unbranched, and cyclic C5 resins, C9 resins, and C10 resins, hydrogenated C9 resins, hydrogenated dicyclopentadiene (DCPD), hydrogenated C5 resins, and combinations thereof.

Useful tackifying agents are commercially available under a variety of trade designations including, e.g., the ESCOREZ series of trade designations from ExxonMobil Chemical Company (Houston, Tex.) including, e.g., ESCOREZ 5637 aromatic modified, cycloaliphatic hydrocarbon resin, ESCOREZ 1310LC aliphatic hydrocarbon resin, ESCOREZ 5400 cycloaliphatic hydrocarbon resin, ESCOREZ 5415 cycloaliphatic hydrocarbon resin, and ESCOREZ 5615 aromatic modified, cycloaliphatic hydrocarbon resin, the EASTOTAC series of trade designations from Eastman Chemical Company (Kingsport, Tenn.) including, e.g., EASTOTAC H130W hydrogenated hydrocarbon resin and EASTOTAC H100R hydrogenated hydrocarbon resin, the ARKON series of trade designations from Arakawa Europe GmbH (Germany) including, e.g., ARKON P-125 alicyclic saturated hydrocarbon resin, the REGALITE and REGALREZ series of trade designations from Eastman Chemical Company including, e.g., REGALITE R1125 fully hydrogenated hydrocarbon resin and REGALREZ 1126 hydrocarbon resin, the RESINALL series of trade designations from Resinall Corp (Severn, North Carolina) including RESINALL R 1030 hydrogenated hydrocarbon resin, and the PICCOLYTE series of trade designations from Pinova Inc. (Brunswick, Ga.) including PICCOLYTE F105 and PICCOLYTE A115 polyterpene resins.

The hot melt adhesive composition includes at least 45% by weight, from 45% by weight to 60% by weight, from 45% by weight to 55% by weight, or even from 45% by weight to 52% by weight tackifying agent.

### Wax

The hot melt adhesive composition optionally includes wax. Suitable waxes include non-functionalized waxes, functionalized waxes, and combinations thereof. Examples of suitable non-functionalized waxes include paraffin waxes, polyolefin waxes (e.g., polypropylene waxes and polyethylene waxes), Fischer Tropsch waxes, microcrystalline waxes, metallocene waxes, and combinations thereof.

Useful paraffin waxes are available under a variety of trade designations including, e.g., PARVAN 1580 and 1520 paraffin waxes from ExxonMobil Chemical Company (Houston, Tex.) and CALUMET FR-6513 from Calumet Specialty Products Partners, LP (Indianapolis, Ind.).

Useful polyethylene waxes are commercially available under a variety of trade designations including, e.g., the EPOLENE series of trade designations from Westlake Chemical Corporation (Houston, Tex.) including, e.g., EPOLENE N-21 and N-14 polyethylene waxes, the BARECO series of trade designations from Baker Hughes Inc. (Sugar Land, Tex.) including, e.g., BARECO C4040 polyethylene wax, the AC series of trade designations from Honeywell Int'l Inc. (Morristown, N.J.) including, e.g., A-C 8 and A-C 9 polyethylene waxes, the POLYWAX series of trade designations including POLYWAX 3000 polyethylene wax from Baker Hughes (Houston, Tex.), and CWP 400 polyethylene wax from Trecora Chemical (Pasedena, Tex.).

Useful polypropylene waxes are commercially available under a variety of trade designations including, e.g., EPOLENE N-15 from Westlake Chemical, HONEYWELL AC1089 from Honeywell Int'l Inc., and LICOCENE 6102 from Clariant Int'l Ltd. (Muttenz, Switzerland).

Useful Fischer Tropsch waxes are commercially available under a variety of trade designations including, e.g., the BARECO series of trade designations from Baker Hughes Inc. (Sugar Land, Tex.) including, e.g., BARECO PX-100 and PX-105 Fischer Tropsch waxes, the SHELLWAX series of trade designations from Shell Malaysia Ltd. (Kuala Lumpur, Malaysia) including, e.g., SHELLWAX SX100 and SX105 Fischer Tropsch waxes, the VESTOWAX series of trade designations from Evonik Industries AG (Germany) including, e.g., VESTOWAX 2050 Fischer Tropsch wax, and the SASOLWAX series of trade designations from Sasol Wax North America Corporation (Hayward, Calif.) including, e.g., SASOLWAX H105, C80, H1, and H4 Fischer Tropsch waxes. Examples of suitable functionalized waxes include functionalized polypropylene wax (e.g., maleated polypropylene wax and oxidized polypropylene wax), functionalized polyethylene wax (e.g., maleated polyethylene wax and oxidized polyethylene wax), polar waxes, functionalized stearamide waxes (e.g., hydroxystearamide, N-(2-hydroxy ethyl)-12-hydroxystearamide, N,N′-ethylene bis 12-hydroxystearamide, and 12-hydroxy stearic acid N,N′-ethylene-bis stearamide), and combinations thereof. Useful commercially available functionalized waxes include, e.g., A-C 597P, A-C 596P, and A-C 1325 maleated polypropylene waxes and A-C 573 maleated polyethylene wax all of which are available from Honeywell Int'l Inc. (Morristown, N.J.), and EPOLENE E 43 maleated polypropylene wax available from Westlake Chemical Corporation (Houston, Tex.).

The hot melt adhesive composition preferably includes less than 5% by weight, less than 3% by weight, from 1% by weight to 5% by weight, from 1% by weight to 4% by weight, or even from 1% by weight to 3% by weight wax.

### Additional Components

The hot melt adhesive composition optionally additionally includes, e.g., tackifying agents having softening points less than 90° C., other polymers, antioxidants, adhesion promoters, ultraviolet light stabilizers, rheology modifiers, biocides, corrosion inhibitors, dehydrators, colorants (e.g., pigments and dyes), fillers, surfactants, flame retardants, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, N.J.), and ETHYL 702 4,4′-methylene bis(2,6-di-tert-butylphenol). When present, the adhesive composition preferably includes from about 0.1% by weight to 2% by weight antioxidant.

### Uses

The hot melt adhesive composition is useful in a variety of forms including, e.g., as a coating (e.g., continuous coatings and discontinuous coatings (e.g., random, pattern, and array)), bead, film (e.g., a continuous films and discontinuous films), fibers, and combinations thereof. The hot melt adhesive composition can be applied to or incorporated in a variety of substrates and articles including, e.g., woven and nonwoven webs (e.g., webs made from fibers (e.g., yarn, thread, filaments, microfibers, blown fibers, and spun fibers) and nonwoven polypropylene webs), films (e.g., polyolefin films (e.g., polypropylene films and polyethylene films), films derived from plant materials (e.g., starch-derived polymer films, and polyester films (e.g., polylactic acid films)), nylon, rayon, polyester, polyvinyl chloride, and polyurethane films, and combinations thereof), perforated films, tape backings, fibers, substrates made from fibers (e.g., synthetic polymer fibers (e.g., nylon, rayon, polyesters, acrylics, polypropylenes, polyethylene, polyvinyl chloride, and polyurethane synthetic polymer fibers), virgin fibers, recycled fibers, cellulose fibers (e.g., natural cellulose fibers such as wood pulp), natural fibers (e.g., cotton, silk and wool), fibers made from natural materials including, e.g., polylactic acid, and glass fibers, and combinations thereof)), release liners, porous substrates, sheets (e.g., paper, and fiber sheets), paper products, labels (e.g., paper and polypropylene labels), substrates used in diapers, feminine hygiene (e.g., sanitary napkins), adult incontinence articles, containers (e.g., polyethylene terephthalate, polypropylene, and polyethylene), and combinations thereof.

The hot melt adhesive composition is useful in a variety of applications including, e.g., as a construction adhesive to bond polymer film (e.g., a diaper back sheet) to nonwoven substrate (e.g., a nonwoven web), to bond two polymer films together, to bond two nonwoven substrates together, and combinations thereof. (polyethylene polypropylene derived from starch or derived from polyester (e.g., polylactic acid).

The hot melt adhesive composition can be applied using any suitable application method including, e.g., slot coating, spraying, spray coating (e.g., spiral spray, random spraying, and random fiberization (e.g., melt blowing)), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, “on demand” application methods, and combinations thereof. In on demand hot melt application systems (which are also referred to as “tank free” and “tankless” systems), hot melt compositions are fed in a solid state (e.g., pellets), to a relatively small heating vessel (relative to traditional hot melt applications systems that include a pot) where the hot melt composition is melted and, typically shortly thereafter, the molten liquid is applied to a substrate.

The invention will now be described by way of the following examples. All parts, ratios, percentages, and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Thermal Stability Test Method

An initial viscosity of a sample of the molten hot melt adhesive composition at 135° C. is obtained according to the Viscosity Test Method.

A 200 gram sample of hot melt adhesive composition is placed in a glass beaker (uncovered) and conditioned in a temperature controlled, forced air oven at 135° C. for 200 hours. Then molten sample is removed from the oven and observed with the naked eye for the presence of gel, surface skin formation, charring, and phase separation. The observations are recorded. The molten sample is then tested according to the Viscosity Test Method and the measured viscosity is reported in centipoise.

The absence of gelling, surface skin formation, charring, and visible phase separation indicates that the composition is thermally stable. A change in viscosity of less than 50% from the initial viscosity is acceptable thermal stability.

### Propylene Polymer (PP) Glass Transition Temperature (Tg) Test Method

The glass transition temperature (Tg) of a propylene polymer is determined according to the following test method. A 7.25 mg +/−0.25 mg sample is placed into a pan specific to the differential scanning calorimetry instrument being used (e.g., Discovery DSC 2500 with standard aluminum pans and lids). The sample is then covered with a specified lid and closed. A pan and lid containing no material are also closed and used as a reference sample. The sample is then loaded into the differential calorimeter, covered with a nitrogen blanket, and cooled to a temperature of −90° C. The sample is then equilibrated for 5 minutes at −90° C. The sample is then heated at 10° C. per minute until the sample reaches 180° C.

The data obtained is represented in graphical exothermal down format containing Heat Flow versus Temperature. The glass transition temperature (Tg) is taken as the midpoint of the transition that occurs during the heating cycle (i.e., the cycle from −90° C. to 180° C.) and is reported in degrees centigrade.

### Hot Melt Adhesive Composition (HMA) Glass Transition Temperature and Crossover Temperature Test Method

The glass transition temperature (Tg) and crossover temperature (Tx) of a hot melt adhesive composition are determined according to ASTM D7028. The test method is conducted using a DHR-II instrument and “Advantage for Q Series Version” software or equivalent. The instrument is set to Dynamic Mechanical Analysis (DMA) strain-controlled mode and temperature sweep.

The sample is placed in tension mode in the DMA instrument at a preload force of 0.01 N. The test sample is equilibrated at 130° C., is held at 130° C. for 1 minute (min), then the temperature is decreased to a temperature of 0° C. at a temperature cooling rate of 10° C./min and a frequency of 10 radians per second (1.59 Hertz), conditioned at 0° C. for 10 minutes, and then heated to 130° C. at a rate of 3° C./min and a frequency of 10 radians per second (1.59 Hertz). The Tg is recorded as the first maximum temperature value for Tan Delta (G″/G′) during the heating cycle (i.e., the cycle from 0° C. to 130° C.). The Tx is recorded as the temperature value where Tan Delta (G″/G′)=1.0 during the heating cycle (i.e., the cycle from 0° C. to 130° C.).

If the viscosity of the hot melt adhesive composition to be tested is less than 5000 cP at 121° C., then the above-described DMA method is modified as follows: the equilibration temperature and the first hold temperature are both 120° C. instead of 130° C., and the sample heating cycle is from 0° C. to 120° C. instead of 0° C. to 130° C.

### Viscosity Test Method

The viscosity of a hot melt adhesive composition is determined in accordance with ASTM D-3236 entitled, “Standard Test Method for Apparent Viscosity of Hot Melt Adhesives and Coating Materials,” (Oct. 31, 1988) using a Brookfield Thermosel Viscometer Model RVDV 2+and spindle number 27. The results are reported in centipoise (“cP”).

### Melt Flow Rate Test Method

The melt flow rate of a propylene polymer is determined at 230° C. using a 2.16 kg load in accordance with ASTM D-D1238A-20 entitled, “Standard Test Method for Melt Flow Rates of Thermoplastics by Extrusion Plastometer.” The results are reported in grams (g) per 10 minutes (min) (g/10 min).

### Sample Preparation Method for Dynamic Peel Adhesion Test

A slot coating applicator, which is 3 inch (76.2 mm) wide, and a laminator are set to an application temperature such that the hot melt adhesive composition to be applied exhibits a viscosity of from 1000 cP to 6000 cP unless the temperature is otherwise specified, a nip pressure of 34.5 kilopascal (5 psi), an application weight of 6 grams per square meter (g/m²), and minimal rewind and unwind tensions so as not to stretch the web.

The hot melt adhesive composition is applied continuously at a coat weight of 6 g/m² on a polypropylene nonwoven web having a thickness of 0.1 mm and a basis weight of 15 g/m² as the nonwoven web is passed through the applicator at a speed of from 190 meters per minute (m/min) to 230 m/min with 5 mm deflection. A breathable polyethylene film having a thickness of 0.23 mm, traveling at the same speed as the nonwoven web, is then nipped into place against the adhesive composition and the nonwoven web to form a laminate.

### Dynamic Peel Adhesion Test Method

Dynamic Peel is determined according to ASTM D1876-01 entitled, “Test Method for Determining Peel Resistance of Adhesive (T-Peel Test Method),” with the exception that the test is run at 30.5 centimeters per minute (12 inches per minute) over a period of 10 seconds and 8 replicates are run. The test samples are run on an IMASS Spec-type test instrument in the machine direction. Unless otherwise specified, the test samples are prepared as described in the Sample Preparation Method for Dynamic Peel Adhesion Test. Eight test samples are prepared for each sample composition and the test samples are tested 24 hours after the test sample has been prepared. The average peel value over 10 seconds of peeling is recorded, and the results are reported in units of grams of force per 3 inch (gf/3 inch). The results also can be converted to units of Newtons per centimeter (N/cm). Substrate failure (SF) indicates a peel force exceeding the strength of the substrates, i.e., a force of greater than 1 N/cm.

### Analysis of Polymer TGS

Various propylene polymers were tested according to the Propylene Polymer Glass Transition Temperature Test Method and the results are reported below in Table 1.

TABLE 1

| Polymer Trade Designation | Tg |
|---|---|
| VISTAMAXX 6202 | −31° C. |
| VERSIFY 3401 | −34° C. |
| VERSIFY 4301 | −29° C. |
| VISTAMAXX 6102 | −32° C. |
| VISTAMAXX 6502 | −28° C. |

### Examples 1-3

Hot melt adhesive compositions of Examples 1-3 were prepared by combining the components in the amounts (in % by weight) specified in Table 2 and heating the same to from 150° C. to 175° C. with mixing.

The hot melt adhesive compositions of Examples 1-3 were then tested according to the Thermal Stability, Viscosity, HMA Tg, HMA Tx, and Dynamic Peel Adhesion test methods. The results and the adhesive application temperature used to prepare the test samples for the Dynamic Peel Adhesion test method are set forth below in Table 2.

TABLE 2

| | 1 | 2 | 3 |
|---|---|---|---|
| VISTAMAXX 6102 | 9 | 0 | 6 |
| L-MODU S901 | 0 | 9 | 3 |
| CALSOL 5550 | 38 | 42 | 40 |
| ESCOREZ 5637 | 51.3 | 47.3 | 49.3 |
| EPOLENE N-21 | 1.5 | 1.5 | 1.5 |
| Antioxidant | 0.2 | 0.2 | 0.2 |
| Viscosity | | | |
| at 121° C. (cP) | 13,630 | 1205 | 5325 |
| at 135° C. (cP) | 7088 | N.T. | N.T. |
| at 149° C. (cP) | 4063 | N.T. | N.T. |
| Tg (° C.) | 22 | 17 | 19 |
| Tx (° C.) | 95 | N.A. | 85 |
| Dynamic Peel | 531 | 453 | 536 |
| Adhesion Reported | | | |
| in gf/3 inch | | | |
| Dynamic Peel | 0.68 | 0.58 | 0.69 |
| Adhesion Reported | | | |
| in N/cm | | | |
| Application Temp | 149 | 107 | 121 |
| (° C.) | | | |
| Thermal Stability | Free of | Free of | Free of |
| Observations | charring, | charring, | charring, |
| | skinning, gel, | skinning, gel, | skinning, gel, |
| | and phase | and phase | and phase |
| | separation. | separation. | separation. |
| | Change in | Change in | Change in |
| | Viscosity | Viscosity | Viscosity |
| | was <50% | was <50% | was <50% |

VISTAMAXX 6102 = metallocene catalyzed propylene/ethylene copolymer (ExxonMobil)
L-MODU S901 metallocene catalyzed propylene homopolymer (Idemitsu)
CALSOL 5550 = naphthenic oil (Calumet Specialty Products Partners, LP, Indianapolis, Indiana)
ESCOREZ 5637 = aromatic modified, cycloaliphatic hydrocarbon resin softening point 129.5° C. (ExxonMobil Chemical Co., Houston, Texas)
EPOLENE N-21 = polyethylene wax (Westlake Chemical Corp., Houston, Texas)
ANTIOXIDANT = IRGANOX 1010 hindered phenolic antioxidant (BASF Corp., Florham Park, New Jersey)
NT = Not Tested
NA = The composition did not exhibit a crossover temperature

### Examples 4-6

Hot melt adhesive compositions of Examples 4-6 were prepared by combining the components in the amounts (in % by weight) specified in Table 3 and heating the same to from 150° C. to 175° C. with mixing.

The hot melt adhesive compositions of Examples 4-6 were then tested according to the Thermal Stability, Viscosity, HMA Tg, HMA Tx, and Dynamic Peel Adhesion test methods. The results and the adhesive application temperature used to prepare the test samples for the Dynamic Peel Adhesion test method are set forth below in Table 3.

TABLE 3

| | 4 | 5 | 6 |
|---|---|---|---|
| VISTAMAXX 6102 | 5 | 4 | 3.5 |
| L-MODU S901 | 3 | 3 | 3 |
| CALSOL 5550 | 39.5 | 38.5 | 37 |
| ESCOREZ 5637 | 50.8 | 40 | 0 |
| RESINALL R1030 | 0 | 12.8 | 54.3 |
| EPOLENE N-21 | 1.5 | 1.5 | 2 |
| Antioxidant | 0.2 | 0.2 | 0.2 |
| Viscosity @ | 4288 | 3300 | 2630 |
| 121° C. (cP) | | | |
| Tg (° C.) | 20 | 24 | 26 |
| Tx (° C.) | 84 | 87 | 95 |
| Dynamic Peel | 454 | 413 | 508 |
| Adhesion Reported | | | |
| in gf/3 inch | | | |
| Dynamic Peel | 0.58 | 0.53 | 0.65 |
| Adhesion Reported | | | |
| in N/cm | | | |
| Application Temp | 121 | 116 | 110 |
| (° C.) | | | |
| Thermal Stability | Free of | Free of | Free of |
| Observations | charring, | charring, | charring, |
| | skinning, gel, | skinning, gel, | skinning, gel, |
| | and phase | and phase | and phase |
| | separation. | separation. | separation. |
| | Change in | Change in | Change in |
| | Viscosity | Viscosity | Viscosity |
| | was <50% | was <50% | was <50% |

RESINALL R1030 = hydrogenated cycloaliphatic hydrocarbon resin softening point 130° C. (Resinall Corp., Severn, North Carolina)

### Examples 7-9

Hot melt adhesive compositions of Examples 7-9 were prepared by combining the components in the amounts (in % by weight) specified in Table 4 and heating the same to from 150° C. to 175° C. with mixing.

The hot melt adhesive compositions of Examples 7-9 were then tested according to the Viscosity and HMA Tg test methods. The results are set forth below in Table 4.

TABLE 4

| | 7 | 8 | 9 |
|---|---|---|---|
| CALSOL 5550 | 33 | 33 | 31.5 |
| L-MODU S901 | 3 | 3 | 3 |
| VISTAMAXX 6102 | 6 | 6 | 6 |
| ESCOREZ 5400 | 53.3 | 51.8 | 55.3 |
| EPOLENE N-21 | 2.5 | 4 | 2 |
| Additive* | 2.0 | 2.0 | 2.0 |
| antioxidant | 0.2 | 0.2 | 0.2 |
| Total | 100 | 100 | 100 |
| Viscosity at 135° C. | 3510 | N.T. | 3895 |
| Viscosity at 149° C. | 2380 | 2220 | 2345 |
| Tg (° C.) | 5 | 1 | 15 |

*The additive includes 0.82% by weight polymer based on the total weight of the composition.

Other embodiments are within the claims.

What is claimed is:

1. A hot melt adhesive composition comprising:
from 1% by weight to less than 10% by weight total polymer content, of which from 1% by weight to less than 10% by weight, based on the weight of the hot melt adhesive composition, comprises a single-site catalyzed propylene polymer selected from the group consisting of single-site catalyzed propylene homopolymer, single-site catalyzed propylene/alpha-olefin copolymer, and combinations thereof;
liquid plasticizer; and
from 45% by weight to 60% by weight hydrocarbon tackifying agent having a softening point greater than 90° C.,
the composition exhibiting a viscosity of no greater than 5000 centipoise (cP) at 149° C.

2. The hot melt adhesive of claim 1 comprising from greater than 25% by weight to 45% by weight of the liquid plasticizer.

3. The hot melt adhesive composition of claim 2, wherein the hydrocarbon tackifying agent comprises a tackifying agent having a softening point of at least 110° C.

4. The hot melt adhesive composition of claim 2, wherein the single-site catalyzed propylene polymer is selected from the group consisting of a single-site catalyzed propylene homopolymer having a melt flow rate of less than 100 g/10 min at 230° C. using a 2.16 kg load and a Tg greater than −20° C., a single-site catalyzed propylene/alpha-olefin copolymer having a melt flow rate less than 50 g/10 min at 230° C. using a 2.16 kg load and a Tg greater than −40° C., and combinations thereof.

5. The hot melt adhesive composition of claim 3, wherein the single-site catalyzed propylene polymer is selected from the group consisting of a single-site catalyzed propylene homopolymer having a melt flow rate of less than 100 g/10 min at 230° C. using a 2.16 kg load and a Tg greater than −20° C., a single-site catalyzed propylene/alpha-olefin copolymer having a melt flow rate less than 50 g/10 min at 230° C. using a 2.16 kg load and a Tg greater than −40° C., and combinations thereof.

6. The hot melt adhesive composition of claim 4, wherein the composition comprises from 1% by weight to 5% by weight of the single-site catalyzed propylene homopolymer.

7. The hot melt adhesive composition of claim 4, wherein the composition comprises from 1% by weight to 5% by weight of the single-site catalyzed propylene homopolymer and from 3% by weight to 7% by weight of the single-site catalyzed propylene/alpha-olefin copolymer.

8. The hot melt adhesive composition of claim 7, wherein the single-site catalyzed propylene/alpha-olefin copolymer has an alpha-olefin comonomer content of no greater than 18% by weight.

9. The hot melt adhesive composition of claim 4, wherein the composition comprises the single-site catalyzed propylene homopolymer and the single-site catalyzed propylene/alpha-olefin copolymer.

10. The hot melt adhesive composition of claim 4, wherein the composition comprises the single-site catalyzed propylene/alpha-olefin copolymer, and the single-site catalyzed propylene/alpha-olefin copolymer has a melt flow rate no greater than 25 g/10 min at 230° C. using a 2.16 kg load.

11. The hot melt adhesive composition of claim 4, wherein the single-site catalyzed propylene polymer has a melt flow rate of no greater than 30 g/10 min at 230° C. using a 2.16 kg load.

12. The hot melt adhesive composition of claim 4, wherein the composition exhibits a property selected from the group consisting of a Tg of from 0° C. to 30° C., a crossover temperature of at least 80° C., a viscosity of no greater than 5000 cP at 135° C., or a combination thereof.

13. The hot melt adhesive composition of claim 4, wherein the composition exhibits a viscosity of no greater than 5000 cP at 121° C.

14. The hot melt adhesive composition of claim 4, wherein the composition exhibits a viscosity of no greater than 5000 cP at 107° C.

15. The hot melt adhesive composition of claim 12, wherein the composition exhibits a peel adhesion of at least 300 grams of force per 3 inch when tested according to the Peel Adhesion test method.

16. The hot melt adhesive composition of claim 4, wherein the polymer content further comprises from 1% by weight to 5% by weight styrene block copolymer based on the weight of the hot melt adhesive composition.

17. The hot melt adhesive composition of claim 16 further comprising from 1% by weight to 3% by weight wax.

18. The hot melt adhesive composition of claim 1, wherein the single-site catalyzed propylene polymer is selected from the group consisting of a single-site catalyzed propylene homopolymer having a melt flow rate of less than 100 g/10 min at 230° C. using a 2.16 kg load, a propylene/alpha-olefin copolymer having a melt flow rate of less than 50 g/10 min at 230° C. using a 2.16 kg load, and combinations thereof.

19. The hot melt adhesive composition of claim 1, wherein the single-site catalyzed propylene polymer comprises a single-site catalyzed propylene homopolymer having a melt flow rate of less than 100 g/10 min at 230° C. using a 2.16 kg load and a single-site catalyzed propylene/alpha-olefin copolymer having a melt flow rate of less than 50 g/10 min at 230° C. using a 2.16 kg load.

20. The hot melt adhesive composition of claim 1, wherein the composition comprises from 1% by weight to 5% by weight of the single-site catalyzed propylene homopolymer.

21. The hot melt adhesive composition of claim 1, wherein the hydrocarbon tackifying agent comprises a hydrocarbon tackifying agent having a softening point of at least 100° C.

22. The hot melt adhesive of claim 1 comprising from 30% by weight to 45% by weight of the liquid plasticizer.

23. The hot melt adhesive of claim 1 comprising from 35% by weight to 45% by weight of the liquid plasticizer.

24. An article comprising:
the hot melt adhesive composition of claim 1;
a first substrate; and
a second substrate bonded to the first substrate through the hot melt adhesive composition.
